(19) United States
(12) Patent Application Publication
(10) Pub. No.: US 2017/0214970 A1
(43) Pub. Date: Jul. 27, 2017

(54) SETTING DATA RATES IN A VIDEO CAMERA SYSTEM

(71) Applicant: Fraunhofer-Gesellschaft zur Foerderung der angewan, Munich (DE)

(72) Inventors: Thomas HAUENSTEIN, Nuernberg (DE); Christopher SALOMAN, Stegaurach (DE); Wolfgang THIEME, Schwaig (DE)

(21) Appl. No.: 15/481,730

(22) Filed: Apr. 7, 2017

Related U.S. Application Data
(63) Continuation of application No. PCT/EP2015/072827, filed on Oct. 2, 2015.

(30) Foreign Application Priority Data
Oct. 8, 2014 (DE) 10 2014 220 428.3

(51) Int. Cl. H04N 21/462; H04N 21/2343; H04N 5/783; H04L 29/06; H04N 19/59; H04N 19/146; H04N 19/154; H04N 5/232; H04N 9/804

(52) U.S. Cl. CPC H04N 21/4621; H04N 5/232; H04N 21/234381; H04N 21/234363; H04N 21/234354; H04N 5/783; H04N 9/8042; H04N 19/59; H04N 19/146; H04N 19/154; H04L 65/607

(57) ABSTRACT

A setting device for setting data rates in a video camera system includes video cameras each configured to generate a video data stream having a settable data rate, wherein the video data streams can be delivered to a user terminal via a data network, whereon videos based on the video data streams can be output simultaneously, a video being selected among the videos during a stationary operating state, the selected video being output with a higher quality as compared to the non-selected videos, the setting device being configured to generate setting values for setting the data rates of the video data streams and for transmitting the setting values to the video cameras, the generation of the setting values being performed depending on information as to which video is selected, depending on the number of the video cameras present and depending on an available total data rate of the data network.

### CROSS-REFERENCE TO RELATED APPLICATIONS

This application is a continuation of copending International Application No. PCT/EP2015/072827, filed Oct. 2, 2015, which is incorporated herein by reference in its entirety, and additionally claims priority from German Application No. DE 10 2014 220 428.3, filed Oct. 8, 2014, which is incorporated herein by reference in its entirety.

The present invention relates to setting of data rates in a video camera system comprising a plurality of video cameras, each transmitting, in particular in real-time, a video data stream to a user terminal via a data network, said user terminal being configured to simultaneously present videos based on the video data streams. In this context, provision is made for that one of the videos presented is selectable, so that the selected video will be output with a higher quality than the videos not selected.

### BACKGROUND OF THE INVENTION

As the number of video cameras increases, the data rate that may be used in total by the video cameras and, thus, automatically also the workload of the transmission channel increase as well. Specifically with wireless transmissions in accordance with common WLAN standards, the net data rate sometimes is only at a maximum of 32 Mbit/s (802.11a/h/j) [1]. Provided that of said 32 Mbit/s, 29 Mbit/s are reserved for the video camera system, the maximum number of video cameras would be limited to 2 at a given bit rate of 10 Mbit/s of the video streams. A higher number of video cameras would result in the data rate falling below the value of 10 Mbit/s. Thus, in the event of 6 cameras, only 4.8 Mbit/s would be available in each case for the individual video data streams.

It is known from conventional technology to transmit video data streams via data networks while adapting the data rates.

From sources [2] and [5], a method is known wherein a video signal is coded at different data rates and is stored on a server in the form of several files. Blocks of the different files are then transmitted to the user terminal as a function of the data rate that is currently available. However, this method is not real-time capable.

In addition, it is known from source [3] to adapt the bit rate, the frame rate and the retry rate in video transmissions in wireless networks. This involves obtaining information about the current network bandwidth and varying the above-mentioned parameters by means of said information.

Furthermore, a so-called RTCP rate control method is known from source [4]. It is a feedback mechanism enabling the receiver to inform the transmitter about any packet losses or the like. The transmitter may subsequently adapt transmission parameters. In addition, source [4] disclosed a bit rate manager which estimates network conditions and varies the data rate of a video/audio data stream on the basis of the estimated values.

However, the known methods are not readily applicable in a distributed video camera system.

### SUMMARY

According to an embodiment, a setting device for setting data rates in a video camera system may have a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the setting device being configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network, the setting device being configured such that the available total data rate of the data network is detectable over the course of time and that the setting values are automatically adaptable in the event of a change in the available total data rate.

According to another embodiment, a video camera system may have a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the video camera system including a setting device configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network, the setting device being configured such that the available total data rate of the data network is detectable over the course of time and that the setting values are automatically adaptable in the event of a change in the available total data rate.

Another embodiment may have a method for setting data rates in a video camera system, including a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, a setting device being used for generating setting values for setting the data rates of the video data streams and for transmitting the setting values to the video cameras, said setting values being generated as a function of information as to which video is selected, as a function of the number of the video cameras present and as a function of an available total data rate of the data network, the setting device being used for detecting the available total data rate of the data network over the course of time and for automatically adapting the setting values are in the event of a change in the available total data rate.

According to another embodiment, a non-transitory digital storage medium may have a computer program stored thereon to perform the inventive method when said computer program is run by a computer.

In a first aspect, the object is achieved by a setting device for setting data rates in a video camera system, comprising a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the setting device being configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network.

The video cameras may be so-called webcams, in particular, comprising integrated video encoders. The respective video encoder may generate, in particular, a compressed video data stream in accordance with the standards H.263/H.264/H.265. The data network may be a network based on the internet protocol, in particular.

The user terminal may be, in particular, a computer, for example a personal computer or a tablet computer.

The user terminal may include decoding means for decoding the video data streams.

The videos may be presented on a shared display, in particular on a computer screen. However, the user terminal may also be configured such that the videos are output by being stored and/or forwarded. The decoding means may be configured to control the display by means of a video signal.

Among the videos, a video may be selected in each case which is output, i.e. presented, stored and/or forwarded with a higher quality as compared to the non-selected videos. The higher quality may be reflected by a larger number of pixels presented, a higher number of colors used and/or a higher refresh rate. A stationary operating state in this context is understood to mean an operating state wherein no measures for switching the selected video are performed.

The selected video may be specified, for example, by means of a user action at a user interface, in particular at a computer keyboard. To specify the selected video, an operating command may be transmitted from the user interface to the decoding means. However, cases where the user terminal autonomously determines the selected video are also conceivable. For example, it is possible for the selected video to be newly determined on a periodic basis or in an event-driven manner. This may occur at random or in accordance with a predefined pattern.

The available total data rate of the data network is the data rate which all in all is available for the video data streams. It may be constant if the data network is used exclusively by the video camera system; however, it may also vary if data which is independent of the video camera system is also transmitted via the data network.

The setting device may be configured as a hardware and/or a software. The setting device may be integrated into the user terminal, in particular. However, it may also be provided elsewhere. What is essential, however, is that it is capable of generating, in particular calculating, setting values for the data rates of the video data streams and of transmitting same to the video cameras.

The setting device now enables adapting the data rates of the video data streams for the videos as appropriate to the situation. In particular, the data rate of the video data stream for the selected video may be selected to be sufficiently high for the desired higher quality of the selected video to be ensured. At the same time, the data rates of the video data streams of the non-selected videos may be selected to be lower. By generating the setting values as a function of information as to which video is selected, as a function of the number of video cameras present, and as a function of the available total data rate of the data network, the available total data rate of the data network may be exploited in a particularly efficient manner. The information as to which video is selected, and the number of video cameras present may be transmitted, e.g., from the decoding means to the setting device.

In this manner, the number of video cameras at a given total data rate of the network may be clearly increased as compared to cases where all of the video data streams have the same data rate that was once set. In addition, the selected video may be output with a consistently high quality. The non-selected videos, in contrast, may still be output with an acceptable quality, which enables using them as preview videos, for example, by means of which the user may decide which video he/she wishes to use as the selected video.

The invention is particularly suited for real-time capable video camera systems, so that the video camera system is suitable, e.g., for traffic supervision, for supervising public places and for transmitting sports events.

In accordance with an advantageous further development of the invention, the setting device is configured such that the setting values are transmitted via the data network. In this manner, the infrastructure, which is present anyway, may be exploited for transmitting the setting values, so that the video camera system may be realized in a simple manner. In principle, however, it is also possible to transmit the setting values from the setting device to the video cameras in a different manner.

In accordance with an advantageous further development of the invention, the data network is a WLAN. A WLAN (wireless local area network) is understood to mean a wireless local area network which is configured, e.g., in accordance with a standard of the IEEE-802.11 family. When installing the video camera system, one may thus dispense with expensive cabling for transmitting the data. Despite the limited total data rate of WLANs, the invention nevertheless enables using a multitude of video cameras and presenting the selected video with a high quality.

In accordance with an advantageous further development of the invention, the setting device is configured such that the available total data rate of the data network is detectable over the course of time and that the setting values are automatically adaptable in the event of a change in the available total data rate. Automatic adaptation of the setting values to the available total data rate prevents interferences in the presentation of the videos due to the available total data rate being exceeded, on the one hand, and thus ensures that the videos are presented with the best quality possible, on the other hand. To this end, the user terminal may be provided with means for monitoring the available total data rate, said means receiving, from the data network, an analysis signal corresponding with the available total data rate.

In accordance with a convenient further development of the invention, the setting device is configured to synchronize the video cameras to a shared time basis. In this manner it can be ensured that the video cameras simultaneously use the setting values in each case provided for a specific time period, so that exceeding of the available total data rate when adapting the setting values may be prevented.

In accordance with an advantageous further development of the invention, the setting device is configured such that the setting values are generated, during a process of switching from a previously selected video to a newly selected video, such that in a first phase, the data rate of the video data stream for the previously selected video is maintained, the data rate of the video data stream for the newly selected video is increased, and the data rates of the video data streams for the remaining videos are decreased, and that in a second phase, the data rate of the video data stream for the previously selected video is decreased, the data rate of the video data stream for the newly selected video is maintained, and the data rates of the video data streams for the remaining videos are increased.

It is the core idea of this aspect of the invention, starting from a stationary state, to increase, in the first phase, the data rate of the video data stream for the newly selected video and to set, at the end of the first phase, the newly selected video as the newly selected video at the user terminal. In the second phase, the setting values are then transferred to a new stationary state. In this manner it is ensured that the newly selected video may immediately be presented with a high quality upon switching from the previously selected video to the newly selected video. Decreasing of the data rates of the video data streams of the remaining videos, i.e. of those videos not involved in the switching, or changing, process, enables increasing the data rates of the video data stream of the newly selected video in the first phase without the data rate that may actually be used exceeding the available total data rate in the process. Decreasing of the data rate of the previously selected video then enables, in the second phase, re-increasing the data rates of the video data streams of the remaining videos, so that the latter may be presented with the best quality possible.

In accordance with an advantageous further development of the invention, the setting device is configured such that the setting values are generated, during the process of switching from the previously selected video to the newly selected video, such that in the first phase, the data rate of the video data stream for the newly selected video is increased in several stages, and the data rates of the video data streams for the remaining videos are decreased in several stages, and that in the second phase, the date rate of the video data stream for the previously selected video is decreased in several stages, and the data rates of the video data streams for the remaining videos are increased in several stages. What can be achieved in this manner is that the quality of the presentation of the remaining videos is slowly reduced until the switching process and is slowly increased again after the switching process. In this manner, the consequent presentation of the remaining videos is more pleasant to the human eye.

In accordance with a convenient further development of the invention, the setting device is configured such that the setting values both in the first phase and in the second phase are generated such that the sum of all data rates of the video streams is smaller than or equal to the available total data rate of the data network. In this manner, interferences in the presentation of the videos, for example jitter or still images, are avoided.

In accordance with a convenient further development of the invention, the setting device is configured such that the setting values are generated such that in the first phase, the data rates of the video data streams for the remaining videos are decreased to zero. In this manner, the possible data rate for the previously selected video and the newly selected video is maximized without the available total data rate being exceeded in the process.

In accordance with an advantageous further development of the invention, the setting device is configured such that the setting values for the stationary operating state are generated such that the setting value for the video camera whose video is selected is smaller than or equal to half the available total data rate. In this manner it is possible, during a switching process, to simultaneously transmit the previously selected video and the newly selected video at the same data rate at which the previously selected video was transmitted during the preceding stationary state, so that during the process of switching from the previously selected video to the newly selected video, there is no leap in quality in the presentation of the videos. If h is the data rate of the video data stream for the selected video, and D is the available total data rate of the data network, the following shall apply in this case:

$$h \leq \frac{D}{2} .$$

In accordance with a convenient further development of the invention, the setting device is configured such that the setting values for the stationary operating state are generated such that the setting value for the video camera whose video is selected is a maximum data rate of the video stream of the video camera, provided that the maximum data rate is smaller than or equal to half the available total data rate. The maximum data rate of the video data stream of the video camera is that data rate which the video camera may supply at the most due to technical limitations. This feature ensures that the selected video may be presented with the best quality possible. If hₘₐₓ is the maximum data rate of the video stream of the video camera, the following shall apply:

$${h}_{max} \leq \frac{D}{2} h = {h}_{max} .$$

In accordance with an advantageous further development of the invention, the setting device is configured such that the setting values are generated such that in the first phase, the data rates of the video data streams for the remaining videos are decreased to a minimum data rate of the video data streams of the video cameras. The minimum data rate of the video data streams is that smallest data rate possible that the respective camera is capable of providing. In this manner it is ensured, on the one hand, that the remaining videos can be presented without any interruption during a switching process and, on the other hand, that the data rates can be maximized for the video data streams of the previously selected video and of the newly selected video. If p is the data rate of the non-selected video cameras, and pₘᵢₙ is the minimum data rate of the video cameras, the following shall apply in this case:

p=pₘᵢₙ.

In accordance with an advantageous further development of the invention, the setting device is configured such that the setting values for the stationary operating state are generated such that the setting value for the video camera whose video is selected is smaller than or equal to the difference between half the available total data rate and the product of half the minimum data rate of the video streams of the video cameras times a number, reduced by two, of the video cameras present in total. In this manner, it can be ensured that the total data rate is not exceeded during a switching process if the remaining videos are to be presented without any interruption during said switching process. If n is the number of video cameras present in total, the following shall apply:

$$h \leq \frac{D}{2} - \frac{{p}_{min}}{2} ( n - 2 ) .$$

In accordance with a convenient further development of the invention, the setting device is configured such that the setting values for the stationary operating state are generated such that the setting value for the video camera whose video is selected is a maximum data rate of the video data stream of the video camera, provided that the maximum data rate is smaller than or equal to the difference between half the available total data rate and the product of half the minimum data rate of the video data streams of the video cameras times a number, reduced by two, of the video cameras present in total. In this manner, the quality of the selected video may be maximized if the remaining videos are to be presented without any interruption during a switching process and without the available total data rate being exceeded. The following shall apply:

$${h}_{max} \leq \frac{D}{2} - \frac{{p}_{min}}{2} ( n - 2 ) h = {h}_{max} .$$

In accordance with an advantageous further development of the invention, the setting device is configured such that the setting values for the stationary operating state are generated such that the setting values for the non-selected video cameras are smaller than or equal to the quotient of the difference between the available total data rate and the setting value for the video camera whose video is selected, and the number, reduced by one, of the video cameras present in total. In this manner, the non-selected videos can be output with the best quality possible without the available total data rate being exceeded. If p designates the data rate of the non-selected videos, the following shall apply:

$$p \leq \frac{D - h}{n - 1}$$

In a further aspect, the object is achieved by a video camera system comprising a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the video camera system including a setting device configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network. The advantages discussed in the context of the setting device result.

In a further aspect, the object is achieved by a method for setting data rates in a video camera system, comprising a plurality of video cameras, each of which is configured to generate a video data stream having a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the setting device being used for generating setting values for setting the data rates of the video data streams and for transmitting the setting values to the video cameras, said setting values being generated as a function of information as to which video is selected, as a function of the number of the video cameras present and as a function of an available total data rate of the data network. The advantages discussed in the context of the setting device result.

In a further aspect, the object is achieved by a computer program for performing an inventive method, when the computer program is executed on a computer or processor.

### BRIEF DESCRIPTION OF THE DRAWINGS

Embodiments of the present invention will be detailed subsequently referring to the appended drawings, in which:

FIG. 1 shows an embodiment of a setting device in a video camera system in a schematic representation;

FIG. 2 shows a first embodiment of an operational procedure of the setting device with a process of switching from a previously selected video to a newly selected video, wherein the remaining videos are switched off for a short period of time; and

FIG. 3 shows a second embodiment of an operational procedure of the setting device with a process of switching from a previously selected video to a newly selected video, wherein the remaining videos are presented without any interruption.

### DETAILED DESCRIPTION OF THE INVENTION

Elements which are identical or similar or elements which have identical or equivalent functions shall be provided with identical or similar reference numerals below.

In the description which follows, embodiments comprising a multitude of features of the present invention will be described in more detail in order to convey improved understanding of the invention. However, it shall be noted that the present invention may also be implemented while omitting individual ones of the features described. It shall also be noted that the features shown in various embodiments may also be differently combined unless this is explicitly excluded or would result in conflicts.

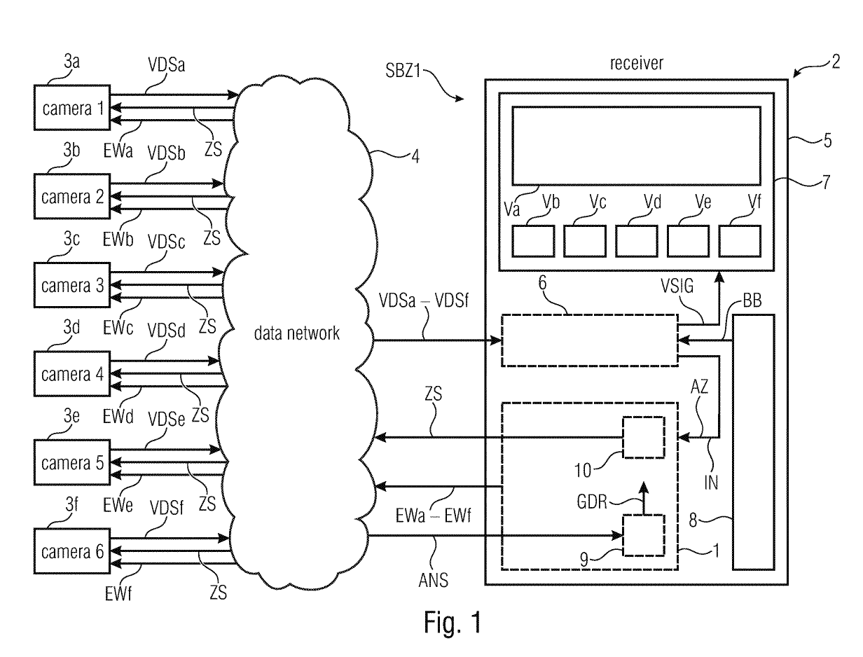

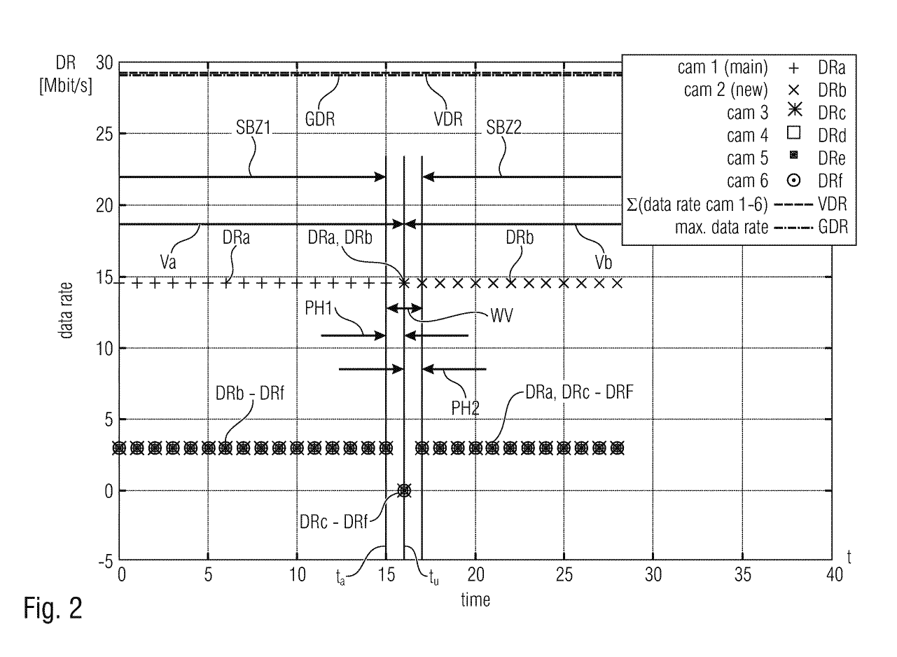

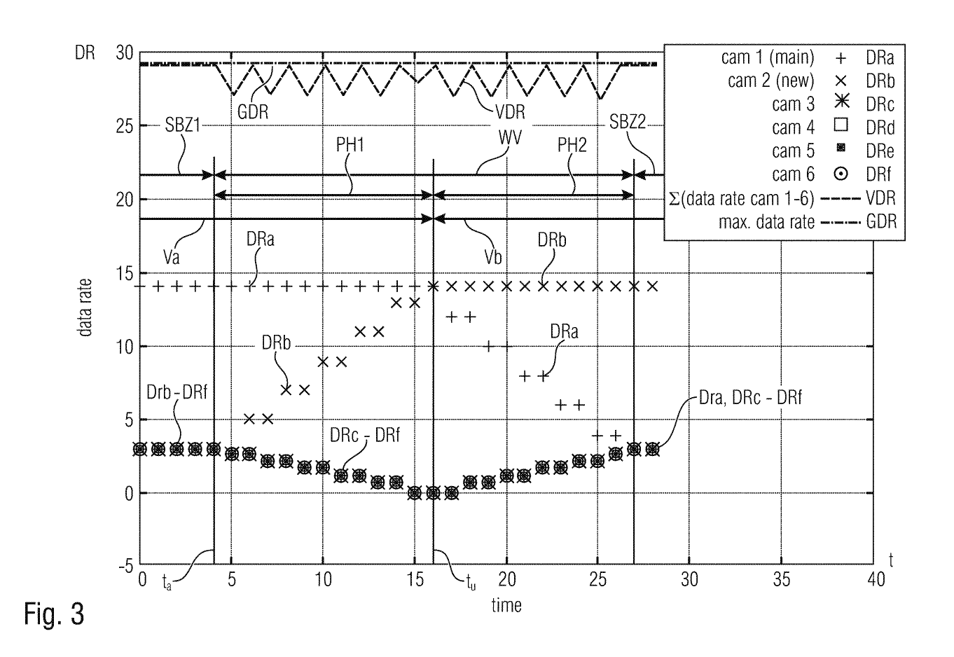

FIG. 1 shows an embodiment of a setting device 1 for setting data rates DRa-DRf (cf. FIGS. 2 and 3) in a video camera system 2, comprising a plurality of video cameras 3a-3f, each of which is configured to generate a video data stream VDSa-VDSf having a settable data rate DRa-DRf, wherein the video data streams VDSa-VDSf can be delivered to a user terminal 5 via a data network 4, on which user terminal 5 videos Va-Vf based on the video data streams VDSa-VDSf can be output at the same time, a video Va; Vb being selected among the videos Va-Vf during a stationary operating state SBZ1; SBZ2, said selected video Va; Vb being output with a higher quality as compared to the non-selected videos Vb-Vf; Va, Vc-Vf, the setting device 1 being configured to generate setting values EWa-EWf for setting the data rates DRa-DRf of the video data streams VDSa-VDSf and for transmitting the setting values EWa-EWf to the video cameras 3a-3f, said generation of the setting values EWa-EWf being performed as a function of information IN as to which video Va; Vb is selected, as a function of the number AZ of the video cameras 3a-3f present and as a function of an available total data rate GDR of the data network 4.

The video cameras 3a-3f may be so-called webcams 3a-3f, in particular, comprising integrated video encoders. The respective video encoder may generate, in particular, a compressed video data stream VDSa-VDSf in accordance with the standards H.263/H.264/H.265. The data network 4 may be a network 4 based on the internet protocol, in particular.

The user terminal 5 may be, in particular, a computer 5, for example a personal computer or a tablet computer.

The user terminal 5 may include decoding means 6 for decoding the video data streams VDSa-VDSf.

The videos Va-Vf may be presented on a shared display 7, in particular on a computer screen 7. However, the user terminal 5 may also be configured such that the videos Va-Vf are output by being stored and/or forwarded. The decoding means 6 may be configured to control the display 7 by means of a video signal VSIG.

In a stationary operating state SBZ1, among the videos Va-Vf, a video Va may be selected in each case which is output, i.e. presented, stored and/or forwarded with a higher quality as compared to the non-selected videos Vb-Vf. In FIG. 1, a stationary operating state SBZ1 is shown wherein the video Va of the video camera 3a is selected. The higher quality may be reflected by a larger number of pixels presented, a higher number of colors used and/or a higher refresh rate. A stationary operating state SBZ1; SBZ2 in this context is understood to mean an operating state wherein no measures for switching the selected video Va are performed.

The selected video Va may be specified, for example, by means of a user action BB at a user interface 8, in particular at a computer keyboard 8. To specify the selected video Va, an operating command BB may be transmitted from the user interface 8 to the decoding means 6. However, cases where the user terminal 5 autonomously determines the selected video Va are also conceivable. For example, it is possible for the selected video Va to be newly determined on a periodic basis or in an event-driven manner. This may occur at random or in accordance with a predefined pattern.

The available total data rate GDR of the data network 4 is the data rate which all in all is available for the video data streams VDSa-VDSf. It may be constant if the data network 4 is used exclusively by the video camera system 2; however, it may also vary if data which is independent of the video camera system 2 is also transmitted via the data network 4.

The setting device 1 may be configured as a hardware and/or a software. The setting device 1 may be integrated into the user terminal 5, in particular. However, it may also be provided elsewhere. What is essential, however, is that it is capable of generating, in particular calculating, setting values EWa-EWf for the data rates DRa-DRf of the video data streams and of transmitting same to the video cameras 3a-3f.

The setting device 1 now enables adapting the data rates DRa-DRf of the video data streams VDSa-VDSf for the videos Va-Vf as appropriate to the situation. In particular, the data rate DRa of the video data stream VDSa for the selected video Va may be selected to be sufficiently high for the desired higher quality of the selected video Va to be ensured. At the same time, the data rates DRb-DRf of the video data streams of the non-selected videos Vb-Vf may be selected to be lower. By generating the setting values EWa-EWf as a function of information IN as to which video Va-Vf is selected, as a function of the number of video cameras present AZ, and as a function of the available total data rate GDR of the data network 4, the available total data rate GDR of the data network 4 may be exploited in a particularly efficient manner. The information IN as to which video Va-Vf is selected, and the number AZ of video cameras 3a-3f present may be transmitted, e.g., from the decoding means 6 to the setting device 1.

In this manner, the number AZ of video cameras 3a-3f at a given total data rate GDR of the network 4 may be clearly increased as compared to cases where all of the video data streams VDSa-VDSf have the same data rate that was once set. In addition, the selected video Va may be output with a consistently high quality. The non-selected videos Vb-Vf, in contrast, may still be output with an acceptable quality, which enables using them as preview videos Va-Vf, for example, by means of which the user may decide which video he/she wishes to use as the selected video Va.

The invention is particularly suited for real-time capable video camera systems 2, so that the video camera system 2 is suitable, e.g., for traffic supervision, for supervising public places and for transmitting sports events.

In accordance with an advantageous further development of the invention, the setting device 1 is configured such that the setting values EWa-EWf are transmitted via the data network 4. In this manner, the infrastructure, which is present anyway, may be exploited for transmitting the setting values EWa-EWf, so that the video camera system 2 may be realized in a simple manner. In principle, however, it is also possible to transmit the setting values EWa-EWf from the setting device 1 to the video cameras 3a-3f in a different manner.

In accordance with an advantageous further development of the invention, the data network 4 is a WLAN 4. A WLAN 4 (wireless local area network) is understood to mean a wireless local area network 4 which is configured, e.g., in accordance with a standard of the IEEE-802.11 family. When installing the video camera system 2, one may thus dispense with expensive cabling for transmitting the video data streams VDSa-VDSf. Despite the limited total data rate GDR of WLANs 4, the invention nevertheless enables using a multitude of video cameras 3a-3f and presenting the selected video Va with a high quality.

In accordance with an advantageous further development of the invention, the setting device 1 is configured such that the available total data rate GDR of the data network 4 is detectable over the course of time and that the setting values EWa-EWf are automatically adaptable in the event of a change in the available total data rate GDR. Automatic adaptation of the setting values EWa-EWf to the available total data rate GDR prevents interferences in the presentation of the videos Va-Vf due to the available total data rate GDR being exceeded, on the one hand, and thus ensures that the videos Va-Vf are presented with the best quality possible, on the other hand. To this end, the user terminal 5 may be provided with means 9 for monitoring the available total data rate GDR, said means receiving, from the data network 4, an analysis signal ANS corresponding with the available total data rate GDR.

In accordance with a convenient further development of the invention, the setting device 1 is configured to synchronize the video cameras 3a-3f to a shared time basis. In this manner it can be ensured that the video cameras 3a-3f simultaneously use the setting values EWa-EWf in each case provided for a specific time period, so that exceeding of the available total data rate GDR when adapting the setting values EWa-EWf may be prevented.

In a further aspect, the object is achieved by a video camera system 2 comprising a plurality of video cameras 3a-3f, each of which is configured to generate a video data stream VDSa-VDSf having a settable data rate DRa-DRf, wherein the video data streams VDSa-VDSf can be delivered to a user terminal 5 via a data network 4, on which user terminal 5 videos Va-Vf based on the video data streams VDSa-VDSf can be output at the same time, a video Va; Vb being selected among the videos Va-Vf during a stationary operating state SBZ1; SBZ2, said selected video Va; Vb being output with a higher quality as compared to the non-selected videos Vb-Vf; Va, Vc-Vf, the video camera system 2 including a setting device 1 configured to generate setting values EWa-EWf for setting the data rates DRa-DRf of the video data streams VDSa-VDSf and for transmitting the setting values EWa-EWf to the video cameras 3a-3f, said generation of the setting values EWa-EWf being performed as a function of information IN as to which video Va; Vb is selected, as a function of the number AZ of the video cameras 3a-3f present and as a function of an available total data rate GDR of the data network 4.

In a further aspect, the object is achieved by a method for setting data rates in a video camera system 2, comprising a plurality of video cameras 3a-3f, each of which is configured to generate a video data stream VDSa-VDSf having a settable data rate DRa-DRf, wherein the video data streams VDSa-VDSf can be delivered to a user terminal 5 via a data network 4, on which user terminal 5 videos Va-Vf based on the video data streams VDSa-VDSf can be output at the same time, a video Va; Vb being selected among the videos Va-Vf during a stationary operating state SBZ1; SBZ2, said selected video Va; Vb being output with a higher quality as compared to the non-selected videos Vb-Vf; Va, Vc-Vf, the setting device 1 being used for generating setting values EWa-EWf for setting the data rates DRa-DRf of the video data streams VDSa-VDSf and for transmitting the setting values EWa-EWf to the video cameras 3a-3f, said setting values EWa-EWf being generated as a function of information IN as to which video Va; Vb is selected, as a function of the number AZ of the video cameras 3a-3f present and as a function of an available total data rate GDR of the data network 4.

In a further aspect, the object is achieved by a computer program for performing an inventive method, when the computer program is executed on a computer 5 or processor.

FIG. 2 shows a first embodiment of an operational procedure of the setting device 1 with a process of switching WV from a previously selected video Va to a newly selected video Vb, wherein the remaining videos Vc-Vf are switched off for a short period of time. Prior to the switching process WV, the setting device 1 is operated in a first stationary operating state SBZ1, and following the switching process WV, it is operated in a second stationary operating state SBZ2.

In accordance with an advantageous further development of the invention, the setting device 1 is configured such that the setting values EWa-EWf are generated, during a process of switching WV from a previously selected video Va to a newly selected video Vb, such that in a first phase PH1, the data rate DRa of the video data stream VDSa for the previously selected video Va is maintained, the data rate DRb of the video data stream VDSb for the newly selected video Vb is increased, and the data rates DRc-DRf of the video data streams VDSc-VDSf for the remaining videos Vc-Vf are decreased, and that in a second phase PH2, the data rate DRa of the video data stream VDSa for the previously selected video Va is decreased, the data rate DRb of the video data stream VDSb for the newly selected video Vb is maintained, and the data rates DRc-DRf of the video data streams VDSc-VDSf for the remaining videos Vc-Vf are increased.

It is the core idea of this aspect of the invention, starting from a stationary state SBZ1, to increase, in the first phase PH1, the data rate DRb of the video data stream VDSb for the newly selected video Vb and to set, at the end of the first phase PH1, the newly selected video Vb as the newly selected video Vb at the user terminal 5. In the second phase, the setting values EWa-EWf are then transferred to a new stationary state SBZ2. In this manner it is ensured that the newly selected video Vb may immediately be presented with a high quality upon switching from the previously selected video Va to the newly selected video Vb. Decreasing of the data rates DRc-DRf of the video data streams VDSc-VDSf of the remaining videos Vc-Vf, i.e. of those videos not involved in the switching, or changing, process WV, enables increasing the data rate DRb of the video data stream VDSb of the newly selected video Vb in the first phase PH1 without the data rate VDR that may actually be used exceeding the available total data rate GDR in the process. Decreasing of the data rate DRa of the previously selected video Va then enables, in the second phase PH2, re-increasing the data rates DRc-DRf of the video data streams VDSc-VDSf of the remaining videos Vc-Vf, so that the latter may be presented with the best quality possible.

In accordance with a convenient further development of the invention, the setting device 1 is configured such that the setting values EWa-EWf both in the first phase PH1 and in the second phase PH2 are generated such that the sum of all data rates DRa-DRf of the video streams VDSa-VDSf is smaller than or equal to the available total data rate GDR of the data network 4. The sum of all data rates DRa-DRf of the video streams VDSa-VDSf here corresponds to the data rate VDR that may actually be used. In this manner, interferences in the presentation of the videos, for example jitter or still images, are avoided.

In accordance with a convenient further development of the invention, the setting device 1 is configured such that the setting values EWa-EWf are generated such that in the first phase PH1, the data rates DRc-DRf of the video data streams VDSc-VDSf for the remaining videos Vc-Vf are decreased to zero. In this manner, the possible data rate DRa for the previously selected video Va and the possible data rate DRb for the newly selected video Vb are maximized without the available total data rate GDR being exceeded in the process.

In accordance with an advantageous further development of the invention, the setting device 1 is configured such that the setting values EWa-EWf for the stationary operating state SZB1; SBZ2 are generated such that the setting value EWa; EWb for the video camera 3a; 3b whose video Va; Vb is selected is smaller than or equal to half the available total data rate GDR. In this manner it is possible, during a switching process WV, to simultaneously transmit the previously selected video Va and the newly selected video Vb at the same data rate DRa at which the previously selected video Va was transmitted during the preceding stationary state SZB1, so that during the process of switching WV from the previously selected video Va to the newly selected video Vb, there is no leap in quality in the presentation of the videos Va, Vb. If h is the data rate DRa of the video data stream VDSa for the selected video Va, and D is the available total data rate GDR of the data network 4, the following shall apply in this case:

$$h \leq \frac{D}{2} .$$

In the embodiment of FIG. 2, the total data rate GDR amounts to 29 Mbit/s, and the data rate DRa during the first stationary operating state SBZ1 of the video Va selected therein amounts to 14.5 Mbit/s, according to said equation. Similarly, the data rate DRb amounts to 14.5 Mbit/s during the second stationary operating state SBZ2 of the video Vb selected therein, according to said equation.

In accordance with a convenient further development of the invention, the setting device 1 is configured such that the setting values EWa-EWf for the stationary operating state SZB1; SBZ2 are generated such that the setting value EWa; EWb for the video camera 3a; 3b whose video Va; Vb is selected is a maximum data rate of the video stream VDSa; VDSb of the video camera 3a; 3b, provided that the maximum data rate is smaller than or equal to half the available total data rate GDR. The maximum data rate of the video data stream of the video camera is that data rate which the video camera may supply at the most due to technical limitations. This feature ensures that the selected video may be presented with the best quality possible. If hₘₐₓ is the maximum data rate of the video stream of the video camera, the following shall apply:

$${h}_{max} \leq \frac{D}{2} h = {h}_{max} .$$

However, in the embodiment of FIG. 2, this condition is not met, so that the data rates DRa and DRb amount to 14.5 Mbit/s as described above.

FIG. 3 shows a second embodiment of an operational procedure of the setting device 1 with a process of switching WV from a previously selected video Va to a newly selected video Vb, wherein the remaining videos Vc-Vf are presented without any interruption.

In accordance with an advantageous further development of the invention, the setting device 1 is configured such that the setting values EWa-EWf are generated such that in the first phase PH1, the data rates DRc-DRf of the video data streams VDSc-VDSf for the remaining videos Vc-Vf are decreased to a minimum data rate of the video data streams VDSc-VDSf of the video cameras 3c-3f. The minimum data rate of the video data streams VDSa-VDSc is that smallest data rate possible that the respective camera 3a-3f is capable of providing. In this manner it is ensured, on the one hand, that the remaining videos Vc-Vf can be presented without any interruption during a switching process WV and, on the other hand, that the data rates DRa, DRb can be maximized for the video data streams of the previously selected video Va and of the newly selected video Vb. If p is the data rate of the non-selected video cameras, and pₘᵢₙ is the minimum data rate of the video cameras, the following shall apply in this case:

p=pₘᵢₙ.

In the embodiment of FIG. 3, the data rate of the video cameras 3a-3f amounts to 250 kbit/s.

In accordance with an advantageous further development of the invention, the setting device 1 is configured such that the setting values EWa-EWf for the stationary operating state SZB1; SBZ2 are generated such that the setting value EWa; EWb for the video camera 3a; 3b whose video Va; Vb is selected is smaller than or equal to the difference between half the available total data rate GDR and the product of half the minimum data rate of the video data streams of the video cameras 3a; 3b times a number AZ, reduced by two, of the video cameras 3a-3f present in total. In this manner, it can be ensured that the total data rate GDR is not exceeded during a switching process WV if the remaining videos Vc-Vf are to be presented without any interruption during said switching process WV. If n is the number AZ of video cameras 3a-3f present in total, the following shall apply:

$$h \leq \frac{D}{2} - \frac{{p}_{min}}{2} ( n - 2 ) .$$

In the embodiment of FIG. 3, the total data rate GDR amounts to 29 Mbit/s, and the data rate DRa during the first stationary operating state SBZ1 of the video Va selected therein amounts to 14 Mbit/s, according to said equation. Similarly, the data rate DRb amounts to 14 Mbit/s during the second stationary operating state SBZ2 of the video Vb selected therein, according to said equation.

In accordance with a convenient further development of the invention, the setting device 1 is configured such that the setting values EWa-EWf for the stationary operating state SZB1; SBZ2 are generated such that the setting value EWa; EWb for the video camera 3a; 3b whose video is selected Va; Vb is a maximum data rate of the video data stream VDSa; VDSb of the video camera 3a; 3b, provided that the maximum data rate is smaller than or equal to the difference between half the available total data rate GDR and the product of half the minimum data rate of the video data streams VDSa-VDSf of the video cameras 3a-3f times a number AZ, reduced by two, of the video cameras 3a, 3f present in total. In this manner, the quality of the selected video may be maximized if the remaining videos are to be presented without any interruption during a switching process and without the available total data rate being exceeded. The following shall apply:

$${h}_{max} \leq \frac{D}{2} - \frac{{p}_{min}}{2} ( n - 2 ) h = {h}_{max} .$$

However, in the embodiment of FIG. 3, the above condition is not met, so that the data rates DRa and DRb amount to 14 Mbit/s as described above.

In accordance with an advantageous further development of the invention, the setting device 1 is configured such that the setting values EWa-EWf for the stationary operating state SZB1; SBZ2 are generated such that the setting values for the non-selected video cameras 3b-3f; 3a, 3c-3f are smaller than or equal to the quotient of the difference between the available total data rate GDR and the setting value EWa; EWb for the video camera 3a; 3b whose video Va; Vb is selected, and the number AZ, reduced by one, of the video cameras 3a-3f present in total. In this manner, the videos Vb-Vf not selected in the first stationary operating state SZB1 and/or the videos Va, Vc-Vf not selected in the second stationary operating state SZB2 can be output with the best quality possible without the available total data rate GDR being exceeded. If p designates the data rate of the non-selected videos, the following shall apply:

$$p \leq \frac{D - h}{n - 1}$$

In the embodiment of FIG. 3, a value of 3 Mbit/s results for the data rates DRb-DRf of the videos Vb-Vf not selected in the first stationary operating state SBZ1 and/or for the data rates DRa, DRv-DRf of the videos Va, Vc-Vf not selected in the second stationary operating state SBZ2.

In accordance with an advantageous further development of the invention, the setting device 1 is configured such that the setting values EWa-EWf are generated, during the process of switching WV from the previously selected video Va to the newly selected video Vb, such that in the first phase PH1, the data rate DRb of the video data stream VDSb for the newly selected video Vb is increased in several stages, and the data rates DRc-DRf of the video data streams VDSc-VDSf for the remaining videos Vc-Vf are decreased in several stages, and that in the second phase PH2, the date rate DRa of the video data stream VDSa for the previously selected video Va is decreased in several stages, and the data rates DRc-DRf of the video data streams VDSc-VDSf for the remaining videos Vc-Vf are increased in several stages. What can be achieved in this manner is that the quality of the presentation of the remaining videos Vc-Vf is slowly reduced until the switching process and is slowly increased again after the switching process. In this manner, the consequent presentation of the remaining videos Vc-Vf is more pleasant to the human eye.

A prerequisite for the live system are camera-side video encoders which may dynamically change the data rate of the produced video streams between several definable values. This may be effected by a change in the quality parameters, the resolution or in further parameters (e.g., longer GOP structures for lower bit rates). In addition, the cameras may be synchronized to a shared time basis. This may be implemented by standardized methods such as the network time protocol [6], for example. In the transmission channel a maximum data rate for video transmissions may be predefined as D. The minimum data rate for the preview streams pₘᵢₙ may also be known. Said data rate is defined by means of the specification of the encoder, the values are dependent on the encoder level as well as on the resolution. The data rate hₘₐₓ which may be provided as a maximum by the encoder may also be known. Said data rate may amount to up to 960 Mbit/s in H264, depending on the resolution and the level [7]. The total system includes n≧2 cameras. Initially, the parameters that may be used may be calculated for the standard preview data rate p as well as the data rate of the main stream h.

$$\begin{matrix}( n - 2 ) {p}_{min} + 2 h \leq D & ( 1 ) \\ ( n - 1 ) p - ( n - 2 ) {p}_{min} = h & ( 2 )\end{matrix} \\ p \leq \frac{D + ( n - 2 ) {p}_{min}}{2 ( n - 1 )}$$

$$If$$

$$h > {h}_{max} \\ h = {h}_{max}$$

$$p \leq \frac{D - {h}_{max}}{( n - 1 )}$$

These values may be newly determined during transmission so as to adapt the system to the current network conditions.

Once the starting values have been calculated, camera 3a, which currently is to transmit the main stream, starts to transmit video data to the receiver at the data rate h. All further n−1 cameras also transmit to the receiver 5 at a data rate p. If the main stream is to be switched to a different camera 3b-3f, this may be signalized to all cameras by means of a common broadcasting method. The signal contains a switching time to for which the following applies as a function of the current point in time to and of the round trip time r:

$${t}_{u} > {t}_{a} + \frac{r}{2}$$

Once the signaling has been received, all n−2 cameras with the exception of 3a and 3b start to reduce their data rate from p to pₘᵢₙ. With a delay depending on the encoder, camera 3b continually increases the data rate from p to h. Adaptation of the data rates here is effected by reconfiguring the video encoder used. Whether a bit rate adaptation involves several reconfigurations or only one may depend on the encoder used. Once all cameras have reached their target data rate, the receiver may switch the main stream from 3a to 3b. Once switching has been effected, a further confirmation is sent to all cameras. As a consequence, camera 3a may reduce its data rate down to a value p, whereas all other cameras with the exception of 3b increase their data rate again up to the value p. This method ensures that the maximally available data rate D is not exceeded and that no quality losses will occur during switching of camera streams. The method also allows using only a relatively small data rate even in the event of a large number of cameras. This increases the scalability of the system while the preview streams, unless a switching process currently takes place, are simultaneously also transmitted with the best quality possible.

If, as was mentioned at the outset, a wireless network having a data rate of 29 Mbit/s that is maximally available for the camera system is used as the basis, and if the parameter pₘᵢₙ is set to 250 kbit/s, the following values will result in the event of 6 cameras being used:

$$4 \cdot 0.25 Mbit / s + 2 \cdot h \leq 29 Mbit / s$$

$$5 \cdot p - 4 \cdot 0.25 Mbit / s = h$$

$$p \leq \frac{29 Mbit / s + 1 Mbit / s}{10} \\ p \leq 3 Mbit / s \\ h = 14 Mbit / s$$

In FIG. 2, the switching process is once again illustrated by means of the data rates of the individual cameras. At to =5, a switching process is initiated. Subsequently, the cameras 3c-3f gradually decrease their data rates. With a delay of one time unit, camera 3b increases its data rate. At t=16, the switching process takes places, and camera 3b is used as the main stream. Now, camera 3b gradually reduces its data rate while cameras 3c-3f increase their data rates again with a delay of one time unit. At t=27, all cameras will have reached their target data rates.

The dynamic bit rate adaptation at the encoder during a switching process increases, above all, the scalability of the total system. If all streams were sent at the same data rate, one would either have to have a smaller number of cameras within the system, or all of the cameras would have to transmit at a lower data rate. A smaller number of cameras drastically restricts the fields of application of the system, whereas low data rates result in that the quality of the output video is not satisfactory. Owing to the presented approach, the data rate of the output stream is maintained at a consistently high level, whereas the preview streams can mostly also be displayed with acceptable quality. It is only during a switching process that the user may accept losses in the quality of the preview streams.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### SOURCES

[1] http://www.elektronik-kompendium.de/sites/net/0907051.htm
[2] http://en.wikipedia.org/wiki/Adaptive_bitrate_streaming
[3] U.S. Pat. No. 8,451,910 B1
[4] EP 2 171 927 B1
[5] US 2010/0158101A
[6] http://de.wikipedia.org/wiki/Network_Time_Protocol
[7] http://de.wikipedia.org/wiki/H24#Level

1. A setting device for setting data rates in a video camera system, comprising a plurality of video cameras, each of which is configured to generate a video data stream comprising a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the setting device being configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network, the setting device being configured such that the available total data rate of the data network is detectable over the course of time and that the setting values are automatically adaptable in the event of a change in the available total data rate.

2. The setting device as claimed in claim 1, the setting device being configured such that transmission of the setting values is performed via the data network.

3. The setting device as claimed in claim 1, wherein the data network is WLAN.

4. The setting device as claimed in claim 1, the setting device being configured to synchronize the video cameras to a shared time basis.

5. The setting device as claimed in claim 1, the setting device being configured such that the setting values are generated, during a process of switching from a previously selected video to a newly selected video, such that in a first phase, the data rate of the video data stream for the previously selected video is maintained, the data rate of the video data stream for the newly selected video is increased, and the data rates of the video data streams for the remaining videos are decreased, and that in a second phase, the data rate of the video data stream for the previously selected video is decreased, the data rate of the video data stream for the newly selected video is maintained, and the data rates of the video data streams for the remaining videos are increased.

6. The setting device as claimed in claim 5, the setting device being configured such that the setting values are generated, during the process of switching from the previously selected video to the newly selected video, such that in the first phase, the data rate of the video data stream for the newly selected video is increased in several stages, and the data rates of the video data streams for the remaining videos are decreased in several stages, and that in the second phase, the date rate of the video data stream for the previously selected video is decreased in several stages, and the data rates of the video data streams for the remaining videos are increased in several stages.

7. The setting device as claimed in claim 5, the setting device being configured such that the setting values both in the first phase and in the second phase are generated such that the sum of all data rates of the video streams is smaller than or equal to the available total data rate of the data network.

8. The setting device as claimed in claim 5, the setting device being configured such that the setting values are generated such that in the first phase, the data rates of the video data streams for the remaining videos are decreased to zero.

9. The setting device as claimed in claim 8, the setting device being configured such that the setting values for the stationary operating state are generated such that the setting value for the video camera whose video is selected is smaller than or equal to half the available total data rate.

10. The setting device as claimed in claim 9, the setting device being configured such that the setting values for the stationary operating state are generated such that the setting value for the video camera whose video is selected is a maximum data rate of the video stream of the video camera, provided that the maximum data rate is smaller than or equal to half the available total data rate.

11. The setting device as claimed in claim 5, the setting device being configured such that the setting values are generated such that in the first phase, the data rates of the video data streams for the remaining videos are decreased to a minimum data rate of the video data streams of the video cameras.

12. The setting device as claimed in claim 11, the setting device being configured such that the setting values for the stationary operating state are generated such that the setting value for the video camera whose video is selected is smaller than or equal to the difference between half the available total data rate and the product of half the minimum data rate of the video streams of the video cameras times a number, reduced by two, of the video cameras present in total.

13. The setting device as claimed in claim 12, the setting device being configured such that the setting values for the stationary operating state are generated such that the setting value for the video camera whose video is selected is a maximum data rate of the video data stream of the video camera, provided that the maximum data rate is smaller than or equal to the difference between half the available total data rate and the product of half the minimum data rate of the video data streams of the video cameras times a number, reduced by two, of the video cameras present in total.

14. The setting device as claimed in claim 1, the setting device being configured such that the setting values for the stationary operating state are generated such that the setting values for the non-selected video cameras are smaller than or equal to the quotient of the difference between the available total data rate and the setting value for the video camera whose video is selected, and the number, reduced by one, of the video cameras present in total.

15. A video camera system comprising a plurality of video cameras, each of which is configured to generate a video data stream comprising a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, the video camera system comprising a setting device configured to generate setting values for setting the data rates of the video data streams and for transmitting the setting values to the video cameras, said generation of the setting values being performed as a function of information as to which video is selected, as a function of the number of the video cameras present and as a function of an available total data rate of the data network, the setting device being configured such that the available total data rate of the data network is detectable over the course of time and that the setting values are automatically adaptable in the event of a change in the available total data rate.

16. A method for setting data rates in a video camera system, comprising a plurality of video cameras, each of which is configured to generate a video data stream comprising a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, a setting device being used for generating setting values for setting the data rates of the video data streams and for transmitting the setting values to the video cameras, said setting values being generated as a function of information as to which video is selected, as a function of the number of the video cameras present and as a function of an available total data rate of the data network, the setting device being used for detecting the available total data rate of the data network over the course of time and for automatically adapting the setting values are in the event of a change in the available total data rate.

17. A non-transitory digital storage medium having a computer program stored thereon to perform the method
for setting data rates in a video camera system, comprising a plurality of video cameras, each of which is configured to generate a video data stream comprising a settable data rate, wherein the video data streams can be delivered to a user terminal via a data network, on which user terminal videos based on the video data streams can be output at the same time, a video being selected among the videos during a stationary operating state, said selected video being output with a higher quality as compared to the non-selected videos, a setting device being used for generating setting values for setting the data rates of the video data streams and for transmitting the setting values to the video cameras, said setting values being generated as a function of information as to which video is selected, as a function of the number of the video cameras present and as a function of an available total data rate of the data network, the setting device being used for detecting the available total data rate of the data network over the course of time and for automatically adapting the setting values are in the event of a change in the available total data rate,
when said computer program is run by a computer.
